(19) United States
(12) Patent Application Publication
(10) Pub. No.: US 2012/0258283 A1
(43) Pub. Date: Oct. 11, 2012

(54) SUPER-HYDROPHOBIC SURFACE

(75) Inventors: Jin-seung Sohn, Seoul (KR); Eun-hyoung Cho, Hwaseong-si (KR); Hae-sung Kim, Hwaseong-si (KR)

(73) Assignee: SAMSUNG ELECTRONICS CO., LTD., Suwon-si (KR)

(21) Appl. No.: 13/439,312

(22) Filed: Apr. 4, 2012

(30) Foreign Application Priority Data
Apr. 5, 2011 (KR) 10-2011-0031284

(51) Int. Cl. B32B 3/30

(52) U.S. Cl. 428/156

(57) ABSTRACT

A super-hydrophobic surface may include a first sink pattern and a second sink pattern disposed in a base. The first sink pattern may include first sink grooves extending below an upper surface of the base. The second sink pattern may include second sink grooves which have a size smaller than that of the first sink grooves. The second sink grooves may extend below the upper surface of the base (which may also be a wall of the first sink pattern). Thus, the super-hydrophobic surface may have a structure in which at least two sink patterns are included.

### CROSS-REFERENCE TO RELATED APPLICATION

This application claims priority under 35 U.S.C. §119 to Korean Patent Application No. 10-2011-0031284, filed on Apr. 5, 2011 in the Korean Intellectual Property Office, the disclosure of which is incorporated herein in its entirety by reference.

### BACKGROUND

1. Field

The present disclosure relates to hydrophobic surfaces and, more particularly, to super-hydrophobic surfaces having increased durability.

2. Description of the Related Art

Super-hydrophobicity refers to a physical property of a surface on which wetting is relatively difficult. For example, the leaves of plants, wings of insects, or wings of birds allow certain contaminants to be removed therefrom without requiring any particular removing action or prevention of contamination from the start. This is because the leaves of plants, wings of insects, or wings of birds have super-hydrophobic properties.

An object having a super-hydrophobic surface may have water-proof and anti-contamination characteristics. Therefore, a technology of forming a super-hydrophobic surface may be useful when applied to various industries.

A method of forming a super-hydrophobic surface may be a chemical method or a structural method.

The chemical method of forming a super-hydrophobic surface may be a method of coating a hydrophobic chemical material on a material surface. However, there are limitations in reducing the surface energy of a material using only a chemical treatment.

The structural method of forming a super-hydrophobic surface may be a method of increasing a contact angle between a surface of a solid material and a liquid by increasing the roughness of the surface of the solid material. A super-hydrophobic surface may be realized by taking advantage of a property of a material surface where hydrophobicity increases as the roughness of a surface increases by patterning the material surface. However, when a contact angle is increased by performing protrusion patterning, a relatively complicated pattern or a pattern having a relatively high slenderness ratio is necessary. Thus, a pattern may be relatively easily damaged, thereby reducing practicability.

### SUMMARY

Various example embodiments relate to super-hydrophobic surfaces having higher hydrophobicity and higher durability.

According to a non-limiting embodiment of the present invention, a super-hydrophobic surface may have a structure having at least dual sink patterns. The super-hydrophobic surface may include a base having a first sink pattern and a second sink pattern. The first sink pattern may include first sink grooves extending below a surface of the base (e.g. a solid). The second sink pattern may include second sink grooves which have a size smaller than that of the first sink grooves. The second sink grooves may extend below the surface of the base (which may be an upper surface of a wall of the first sink pattern).

The first sink grooves of the first sink pattern may be disposed in a triangular array.

The first sink grooves of the first sink pattern may be disposed on a center and vertexes of a hexagon formed by disposing the first sink grooves in a regular triangular array.

The second sink grooves of the second sink pattern may be disposed in an overall triangular array.

The second sink grooves of the second sink pattern may be disposed on a center and vertexes of a hexagon formed by disposing the second sink grooves in a regular triangular array.

The surface of the base may further include protruded columns or particles so as to make the surface rougher.

When a size of the first sink grooves or the second sink grooves is d, a gap between adjacent first sink grooves or second sink grooves is p, and a pattern radius λ is λ=d/p, the first sink pattern and the second sink pattern may be formed to satisfy an equation below,

cos θ*=φ_{L}(φ_{S} cos θ_{E}+(φ_{S}−1))+(φ_{L}−1) <Equation>

where θ* is a contact angle on the surface of the base on which the first and second sink patterns are formed, θ_{E} is contact angle on the surface of the base before the first and second sink patterns are formed, and φ_{L} and φ_{S} satisfy φ=1−(π/2\sqrt{3})λ².

A super-hydrophobic structure according to another non-limiting embodiment may include a base having a first surface and an opposing second surface; a plurality of first sink grooves extending from the first surface into the base; and a plurality of second sink grooves disposed between the plurality of first sink grooves, the plurality of second sink grooves extending from the first surface into the base, the plurality of second sink grooves being smaller than the plurality of first sink grooves.

The super-hydrophobic surface according to a non-limiting embodiment of the present invention may have a sink structure on a surface thereof, may have super-hydrophobicity since the sink structure having a relatively small size is formed on the wall that forms the sink structure to increase an area where aft present between a droplet and a solid surface is collected, and may have a relatively strong durability against, for example, scratches since the sink structure increases a surface strength. Also, a dual sink structure may be formed by forming a relatively small sink structure on the relatively large sink structure. Thus, when the small sink structure is damaged, the basic super-hydrophobic structure may still be maintained by the large sink structure, thereby maintaining the relatively high durability of the super-hydrophobic surface.

### BRIEF DESCRIPTION OF THE DRAWINGS

The above and/or other aspects will become more apparent and readily appreciated from the following description of the embodiments, taken in conjunction with the accompanying drawings of which:

FIG. 1 is a schematic drawing showing a contact angle of a droplet on a material surface before texturing the material surface;

FIG. 2 is a schematic drawing showing a contact angle of a droplet on a material surface after texturing the material surface;

FIG. 3 is a scanning electron microscope (SEM) image of a super-hydrophobic surface formed by particle deposition (vapor deposition);

FIG. 4 is a SEM image of a super-hydrophobic surface formed by a sol-gel technology;

FIG. 5 is a SEM image of a super-hydrophobic surface formed by plasma processing;

FIG. 6 is a SEM image of a super-hydrophobic surface formed by an imprint method;

FIG. 7 is a schematic plan view of a portion of a super-hydrophobic surface according to a non-limiting embodiment of the present invention;

FIG. 8 is a cross-sectional view taken along line VIII-VIII of FIG. 7;

FIG. 9 is a schematic drawing showing gaps and sizes of an arrangement of three sink grooves according to a non-limiting embodiment;

FIG. 10 is a schematic plan view of a portion of a super-hydrophobic surface according to another non-limiting embodiment of the present invention; and

FIG. 11 is a cross-sectional view of FIG. 10.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

A super-hydrophobic surface according to a non-limiting embodiment of the present invention may have a structure having two or more sink patterns (e.g., dual sink patterns). As a result, the super-hydrophobic surface may have a relatively high hydrophobicity and durability. The super-hydrophobic surface may be applied in situations where self-cleaning, anti-water drop wetting, and/or low drag force is necessary or desired.

The super-hydrophobic surface may be applied to places where self-cleaning with rain or other water sources is necessary. For example, the super-hydrophobic surface may be applied to the surfaces of solar cells or solar power generators, electronic products (such as outdoor electronic displays), external wars and building glass, and automobile windows and body surfaces. Also, the super-hydrophobic surface may be applied to places where there is a need or desire to secure a clear view by preventing or reducing water drop wetting. For example, the super-hydrophobic surface may be applied to the windows of airplanes and vehicles, rear mirrors of vehicles, and outdoor electronic displays. Also, the super-hydrophobic surface may be applied to places where energy can be saved by reducing friction with water for water transportation and traffic means such as vessels. Also, the super-hydrophobic surface may be applied to places where a hydrophobic surface is required or desired for display processes and to a micro-fluid device that uses micro-fluid engineering.

When a contact area between a droplet that contacts a solid and air present below the droplet is increased, since a surface energy of the droplet contacted with air is relatively high at an interface between the droplet and air, the droplet tends to reduce its total surface energy by becoming rounder, thereby increasing a contact angle with the solid. Accordingly, in order to increase hydrophobicity of a solid, it may be desirable to form as many air pockets as possible below the droplets by, for example, patterning a surface of the solid to increase a distance from a non-contact bottom surface to the solid, and thus, to maintain a relatively large number of air pockets below the droplets even when there are external disturbances.

A principle of generating hydrophobicity by way of a structure will now be described in further detail.

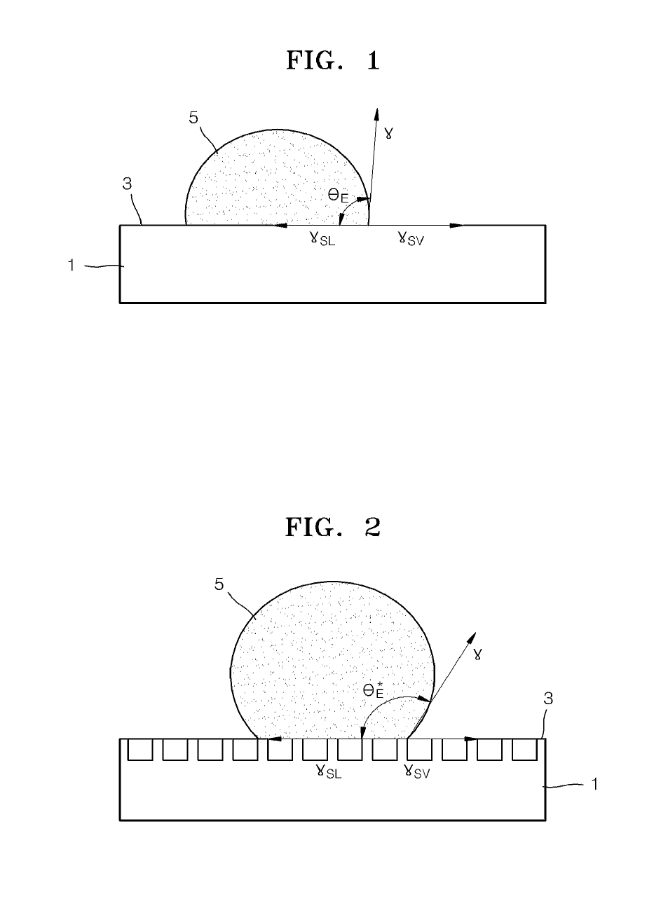

FIG. 1 is a schematic drawing showing a contact angle θ_{E} of a droplet 5 on a surface 3 of a material 1 before texturing the surface 3 of the material 1. FIG. 2 is a schematic drawing showing a contact angle θ_{E}* of the droplet 5 on the surface 3 of the material 1 after texturing the surface 3 of the material 1. As used herein, the material 1 may be referred to as a base or a solid.

A contact angle θ_{E} of the droplet 5 before texturing may be determined by Young's Equation shown in the following equation 1:

cos θ_{E}=(γ_{SV}−γ_{SL})/γ [Equation 1]

where γ_{SV} is an interfacial tension between a solid and a gas, γ_{SL} is an interfacial tension between a solid and a liquid, and γ is an interfacial tension between a liquid and a gas.

An increase in the contact angle θ_{E}* of the droplet 5 after texturing is increased as shown in the following Equation 2:

cos θ_{E}*=−1+φ_{A}(cos θ_{E}+1) [Equation 2]

where φ_{A} is an area fraction of a solid that contacts a liquid droplet

At this point, so as not to wet a textured area, the droplet 5 needs to satisfy the following condition:

$$cos {θ}_{E} < \frac{{φ}_{A} - 1}{γ - {φ}_{A}} \qquad [ Equation 3 ]$$

where γ is a ratio between a protruded area and an actual area. The actual area corresponds to a spread area of a protruded structure.

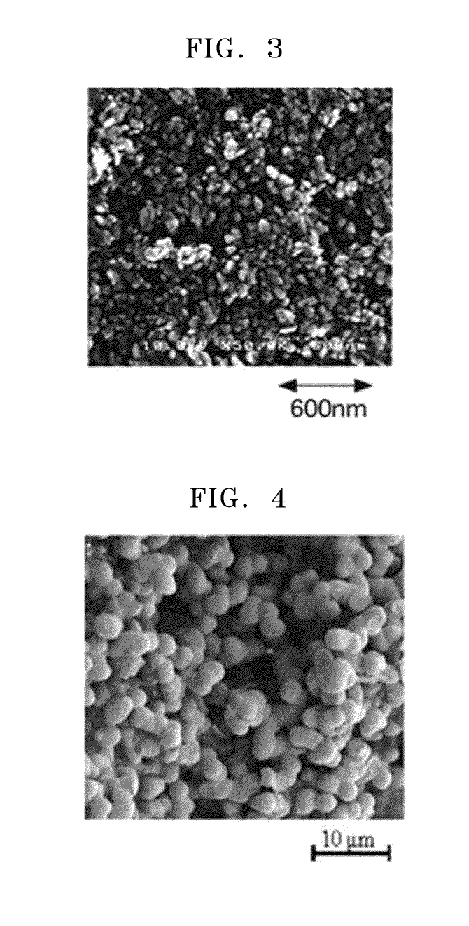

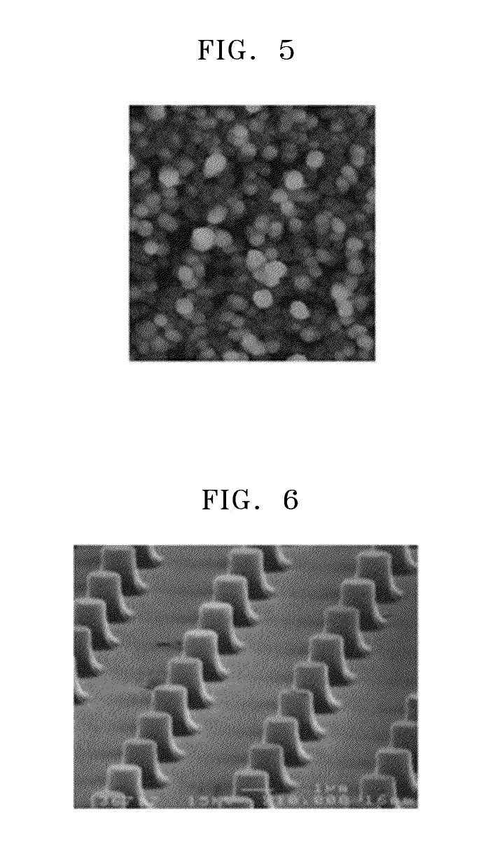

Studies have been conducted to manufacture a solid structure that has a capability of self-cleaning, preventing or reducing formation of water drops, or relatively low drag force through increasing a contact angle according to the above principle. As depicted in FIGS. 3 through 5, when micro or nano particles are coated on a surface of a solid, or as depicted in FIG. 6, when a micro or nano pattern is formed on a surface of a solid, a surface structure may be damaged. Accordingly, super-hydrophobicity may not be maintained, thereby reducing the durability of a super-hydrophobic surface. FIGS. 3 through 5 show cases in which super-hydrophobic surfaces are formed by adhering particles. FIG. 3 is a SEM image of a super-hydrophobic surface formed by particle deposition (vapor deposition). FIG. 4 is a SEM image of a super-hydrophobic surface formed by a sol-gel technology. FIG. 5 is a SEM image of a super-hydrophobic surface formed by plasma processing. FIG. 6 is a SEM image of a super-hydrophobic surface formed by an imprint method.

A super-hydrophobic surface according to a non-limiting embodiment of the present invention is configured to maintain super-hydrophobicity and to overcome a low durability problem of a general super-hydrophobic surface.

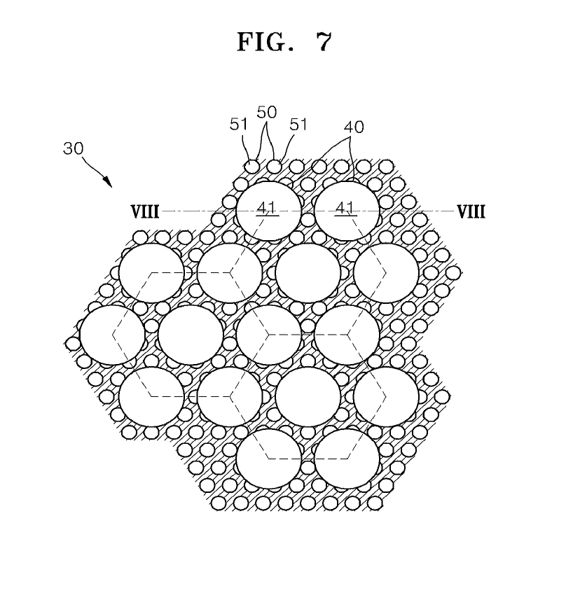

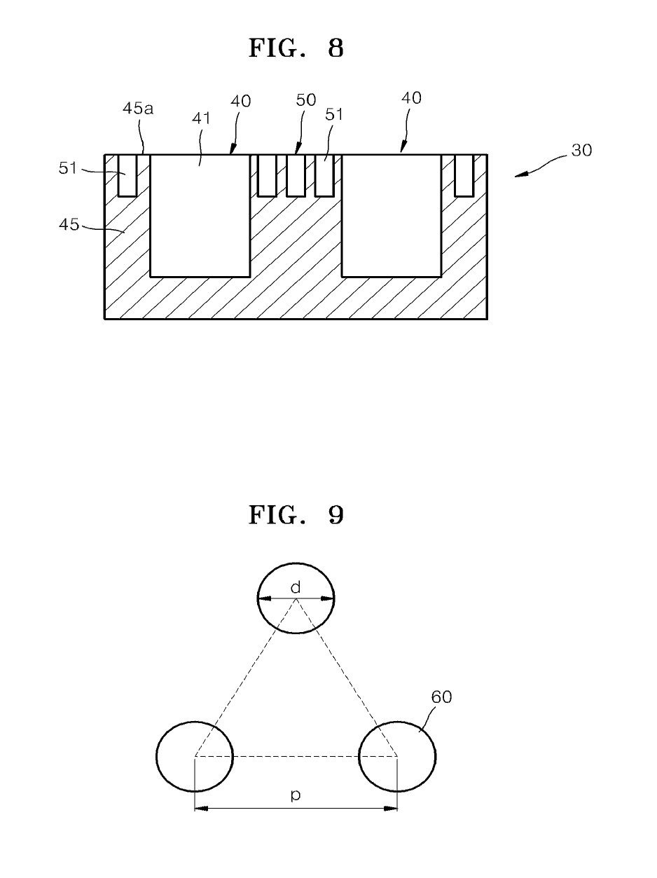

FIG. 7 is a schematic plan view of a super-hydrophobic surface 30 according to a non-limiting embodiment of the present invention, and FIG. 8 is a cross-sectional view taken along a line VIII-VIII of FIG. 7.

Referring to FIGS. 7 and 8, the super-hydrophobic surface 30 has a sink structure. For example, the super-hydrophobic surface 30 may include a structure having at least dual sinks on a surface of a solid or base so as to have higher super-hydrophobicity and durability compared to a protruded structure formed on the surface of the solid. That is, the super-hydrophobic surface 30 includes a sink pattern structure having at least dual sink patterns including a first sink pattern 40 having a relatively large periodicity and a second sink pattern 50 having a relatively small periodicity formed on an upper surface 45a of a wall 45 of the first sink pattern 40. The first sink pattern 40 and second sink pattern 50 extend below the upper surface 45a of the super-hydrophobic surface 30. FIGS. 7 and 8 show an example of the super-hydrophobic surface 30 having the first sink pattern 40 and the second sink pattern 50.

The first sink pattern 40 includes first sink grooves 41 formed by sinking from the upper surface 45a of the solid. The second sink pattern 50 includes second sink grooves 51 that are formed by sinking from the upper surface 45a of the wall 45 of the first sink pattern 40. The second sink grooves 51 have a size that is smaller than that of the first sink grooves 41. For instance the width and/or depth of the second sink grooves 51 may be less than that of the first sink grooves 41.

As depicted in FIG. 7, the first sink grooves 41 of the first sink pattern 40 may be disposed to have a triangular arrangement, for example, a regular triangular arrangement. When the first sink grooves 41 are disposed in a regular triangular arrangement, the first sink grooves 41 of the first sink pattern 40 form an arrangement structure in which the first sink grooves 41 are placed on a center and vertexes of a hexagon. In this way, the first sink pattern 40 may be arranged to have a structure in which the first sink grooves 41 are closely arranged in a hexagon.

The second sink pattern 50 is formed in a sink structure by sinking from the upper surface 45a of the wall 45 of the first sink pattern 40, that is, from the surface of the super-hydrophobic surface 30. The second sink pattern 50 may be arranged such that, for example, the second sink grooves 51 of the second sink pattern 50 are arranged to form an overall triangular arrangement, for example, an overall regular triangular arrangement. The second sink grooves 51 may not be formed on sink regions where the first sink grooves 41 are formed. For instance, the second sink grooves 51 may be formed in an overall triangular arrangement (e.g., an overall regular triangular arrangement) in regions other than where the first sink grooves 41 are formed, that is, on the upper surface 45a of the wall 45 that surrounds the first sink grooves 41. When the second sink grooves 51 are disposed to form an overall regular triangular arrangement, the second sink pattern 50 may form an overall arrangement structure in which the second sink grooves 51 are disposed on a center and vertexes of a hexagon. In this way, the second sink pattern 50 may be arranged to have a structure in which the second sink grooves 51 are closely arranged in a hexagon.

As depicted in FIG. 7, the first sink pattern 40 and the second sink pattern 50 may be formed to configure a dual circular groove surface that is closely filled with hexagons. In FIG. 7, a case where both the first sink grooves 41 of the first sink pattern 40 and the second sink grooves 51 of the second sink pattern 50 are formed in a circular shape is depicted. However, it should be understood that the shapes of the first sink grooves 41 and the second sink grooves 51 may be of various shapes.

As shown in FIG. 7, when the first sink pattern 40 and the second sink pattern 50 configure a dual circular groove surface on which a hexagon is closely formed, a following contact angle may be expected.

FIG. 9 is a schematic drawing showing a gap p and a size d in an arrangement of three sink grooves 60. Referring to FIG. 9, when a size of each sink groove 60 (which may be the first or second sink groove 41 or 51) is d, a gap between adjacent sink grooves 60 is p, and a radius λ of a pattern is λ=d/p, a dual sink pattern structure of the first sink pattern 40 and the second sink pattern 50 may be formed to satisfy the following Equation 4:

cos θ*=φ_{L}(φ_{S} cos θ_{E}+(φ_{S}−1))+(φ_{L}−1)

where θ* is a contact angle of a droplet on a surface of a solid on which the first sink pattern 40 and the second sink pattern 50 are formed, and θ_{E} is a contact angle of the droplet on a surface of a solid before the first sink pattern 40 and the second sink pattern 50 are formed, and φ_{L} and φ_{S} satisfy φ=1−(π/2\sqrt{3})λ².

For example, when a size of the first sink grooves 41 is d_{L} and a gap is p_{L}, a pattern radius λ_{L} is λ_{L}=d_{L}/p_{L} and φ_{L} is φ_{L}=1−(π/2\sqrt{3})λ_{L}². When a size of the second sink grooves 51 is d_{S} and a gap is p_{S}, a pattern radius λ_{S} is λ_{S}=d_{S}/p_{S} and φ_{S} is φ_{S}=1−(π/2\sqrt{3})λ_{S}². cos θ_{E} may be obtained from Equation 1.

A process of obtaining Equation 4, which shows an example of the super-hydrophobic surface 30 having a dual sink pattern structure of the first sink pattern 40 having a relatively a large periodicity and the second sink pattern 50 having a relatively small periodicity will now be described.

The Equation 1 and Equation 5, which are related to energy change per unit (dE), are considered.

dE=(w+v(1−w))γ+(1−v)(1−w)(γ_{SL}−γ_{SV})+γ cos θ* [Equation 5]

When dE=0, energy change is minimized, and when substituted into Equation 5, Equation 6 is obtained:

cos θ*=(1−w)((1−v)cos θ_{E}−v)−w [Equation 6]

The variable w is a fraction of a droplet/gas interface of large air pockets and small air pockets on a surface of a solid below a droplet. The large air pockets may be represented by the relatively large first sink grooves 41, and the small air pockets may be represented by the relatively small second sink grooves 51.

Accordingly, a fraction of a solid/liquid interface of the large air pockets is 1−w, and a fraction of a solid/liquid interface of the small air pockets is 1−v, and thus, φ_{L}=1−w and φ_{S}=1−v. When φ_{L}=1−w and φ_{S}=1−v are substituted into Equation 6, Equation 4 is obtained.

If the first sink grooves 41 and the second sink grooves 51 have the same size, w=v, and when it is assumed that φ=1−w, by substituting this into Equation 6, Equation 7 is obtained.

cos θ*=φ²(cos θ_{E}+1)−1 [Equation 7]

Table 1 shows a design example of a dual sink pattern structure of the first sink pattern 40 that has the relatively large first sink grooves 41 having a relatively large pitch and the second sink pattern 50 that has the relatively small second sink grooves 51 having a relatively large pitch.

TABLE 1

| p_{L} = | 60 μm | Pitch of a first sink groove pattern |
|---|---|---|
| d_{L} = | 58 μm | Diameter of the first sink groove pattern |
| p_{S} = | 8 μm | Pitch of a second sink groove pattern |
| d_{S} = | 7 μm | Diameter of the second sink groove pattern |
| θ = | 110° | Contact angle with respect to a surface of a solid |
| | | having no sink grooves |
| λ_{L} = | 0.9667 | Pattern radius with respect to the first sink groove |
| λ_{S} = | 0.875 | Pattern radius with respect to the second sink groove |
| φ_{L} = | 0.15 | Fraction of solid/liquid interface with respect to the |
| | | first sink groove |
| φ_{S} = | 0.30 | Fraction of solid/liquid interface with respect to the |
| | | second sink groove |
| θ | 166° | Contact angle at a cassie state |

Pattern radii λ_{L} and λ_{S} with respect to the first and second sink grooves 41 and 51 denote ratios between a size (diameter) of a sink groove and a pitch of the sink groove, and, as may be seen from the above description, are values obtained from λ_{L}=d_{L}/p_{L} and λ_{S}=d_{S}/p_{S}. φ_{L} is a value obtained from an equation φ_{S}=1−(π/2\sqrt{3}))λ_{L}², and φ_{S} is a value obtained from an equation φ_{S}=1−(π/2\sqrt{3})λ_{S}².

As it may be seen from the design of Table 1, a contact angle θ of a droplet with respect to a solid surface having no sink grooves is 110°. However, it is seen that a contact angle θ of the droplet with respect to the solid surface on which the dual sink groove patterns of the first sink pattern 40 and the second sink pattern 50 having a sink groove size different from that of the first sink pattern 40 is formed may be greatly increased to 166°.

The super-hydrophobic surface 30 according to a non-limiting embodiment of the present invention may have a sink structure on a surface thereof. As a result, super-hydrophobicity may be attained since a sink structure having a relatively small size is formed on the wall 45, which forms a sink structure, to increase an area where air is present between a droplet and a solid surface. The super-hydrophobic surface 30 may have relatively strong durability against, for example, scratches since the sink structure increases a surface strength. Also, a dual sink structure is formed by forming a small sink structure on the large sink structure. Thus, when the small sink structure is damaged, a basic super-hydrophobic structure may be maintained by the large sink structure, thereby maintaining a relatively high durability of the super-hydrophobic surface 30.

Also, according to the super-hydrophobic surface 30, a pattern having a lower slenderness ratio when compared to a single structure may be used by configuring the sink structure in a dual sink pattern or above, thereby making the process easier. The super-hydrophobic surface 30 may be manufactured with a relatively high productivity process such as a nano-imprint process.

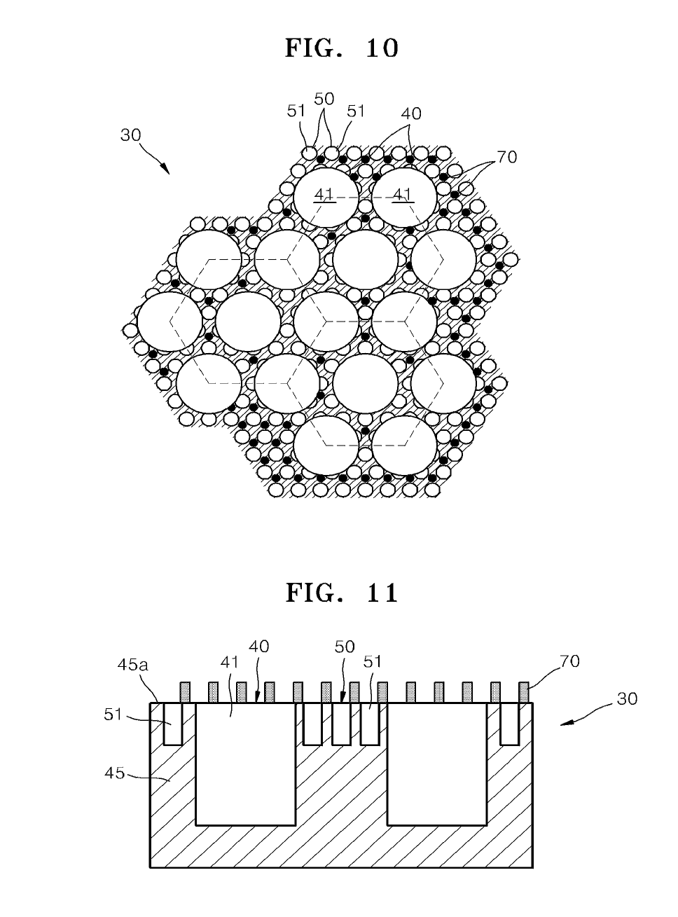

As described above, a case where the super-hydrophobic surface 30 according to a non-limiting embodiment of the present invention may have a sink structure having two or more sink patterns on a solid surface is depicted and described. However, as depicted in FIGS. 10 and 11, the super-hydrophobic surface 30 may be formed to have a rough surface or may be formed to have a protrusion unit 70. The protrusion unit 70 may replace a small sink structure by further including a protrusion unit 70 (e.g., protrusion columns or particles) on a surface of a solid on the dual sink structure. The protrusion unit may also be disposed on the upper surface 45a of the base between the first sink grooves 41 and between the second sink grooves 51. As a result, in the event the protrusion unit 70 is damaged, the super-hydrophobicity may still be maintained since the large sink structure remains therebelow. FIG. 10 is a schematic plan view of a portion of a super-hydrophobic surface according to another non-limiting embodiment of the present invention, and FIG. 11 is a cross-sectional view of FIG. 10.

It should be understood that the example embodiments described therein should be considered in a descriptive sense only and not for purposes of limitation. The descriptions of features or aspects within each non-limiting embodiment should typically be considered as available for other similar features or aspects in other embodiments.

What is claimed is:

1. A super-hydrophobic surface comprising:
a base including a first sink pattern and a second sink pattern, the first sink pattern including first sink grooves extending below a surface of the base, the second sink pattern including second sink grooves, the second sink grooves being smaller than the first sink grooves, the second sink grooves extending below the surface of the base.

2. The super-hydrophobic surface of claim 1, wherein the first sink grooves of the first sink pattern are disposed in a triangular array.

3. The super-hydrophobic surface of claim 2, wherein the first sink grooves of the first sink pattern are disposed so as to define a center and vertexes of a first hexagon.

4. The super-hydrophobic surface of claim 3, wherein when a size of the first sink grooves or the second sink grooves is d, a gap between adjacent first sink grooves or adjacent second sink grooves is p, and a pattern radius λ is λ=d/p, the first sink pattern and the second sink pattern are formed to satisfy an equation shown below,
cos θ*=φ_{L}(φ_{S} cos θ_{E}+(φ_{S}−1))+(φ_{L}−1) <Equation>
where θ* is a contact angle on the surface of the base on which the first and second sink patterns are formed, θ_{E} is a contact angle on the surface of the base before the first and second sink patterns are formed, and φ_{L} and φ_{S} satisfy φ=1=(π/2\sqrt{3})λ².

5. The super-hydrophobic surface of claim 3, wherein the second sink grooves of the second sink pattern are disposed in a triangular array.

6. The super-hydrophobic surface of claim 5, wherein the second sink grooves of the second sink pattern are disposed so as to define a center and vertexes of a second hexagon.

7. The super-hydrophobic surface of claim 6, wherein when a size of the first sink grooves or the second sink grooves is d, a gap between adjacent first sink grooves or adjacent second sink grooves is p, and a pattern radius λ is λ=d/p, the first sink pattern and the second sink pattern are formed to satisfy an equation shown below,
cos θ*=φ_{L}(φ_{S} cos θ_{E}+(φ_{S}−1))+(φ_{L}−1) <Equation>
where θ* is a contact angle on the surface of the base on which the first and second sink patterns are formed, θ_{E} is a contact angle on the surface of the base before the first and second sink patterns are formed, and φ_{L} and φ_{S} satisfy φ=1−(π/2\sqrt{3})λ².

8. The super-hydrophobic surface of claim 2, wherein the second sink grooves of the second sink pattern are disposed in a triangular array.

9. The super-hydrophobic surface of claim 8, wherein the second sink grooves of the second sink pattern are disposed so as to define a center and vertexes of a hexagon.

10. The super-hydrophobic surface of claim 9, wherein when a size of the first sink grooves or the second sink grooves is d, a gap between adjacent first sink grooves or adjacent second sink grooves is p, and a pattern radius λ is λ=d/p, the first sink pattern and the second sink pattern are formed to satisfy an equation shown below,
cos θ*=φ_{L}(φ_{S} cos θ_{E}+(φ_{S}−1))+(φ_{L}−1) <Equation>
where θ* is a contact angle on the surface of the base on which the first and second sink patterns are formed, θ_{E} is a contact angle on the surface of the base before the first and second sink patterns are formed, and φ_{L} of and φ_{S} satisfy φ=1−(π/2\sqrt{3})λ².

11. The super-hydrophobic surface of claim 1, further comprising:
protruding columns or particles on the surface of the base, the protruding columns or particles increasing a profile of the super-hydrophobic surface.

12. The super-hydrophobic surface of claim 1, wherein when a size of the first sink grooves or the second sink grooves is d, a gap between adjacent first sink grooves or adjacent second sink grooves is p, and a pattern radius λ is λ=d/p, the first sink pattern and the second sink pattern are formed to satisfy an equation shown below,
cos θ*=φ_{L}(φ_{S} cos θ_{E}+(φ_{S}−1))+(φ_{L}−1) <Equation>
where θ* is a contact angle on the surface of the base on which the first and second sink patterns are formed, θ_{E} is contact angle on the surface of the base before the first and second sink patterns are formed, and φ_{L} and φ_{S} satisfy φ=1−(π/2\sqrt{3})λ².

13. A super-hydrophobic structure comprising:
a base having a first surface and an opposing second surface, the first surface including a plurality of first sink grooves and a plurality of second sink grooves, the plurality of first sink grooves extending from the first surface into the base, the plurality of second sink grooves disposed between the plurality of first sink grooves, the plurality of second sink grooves extending from the first surface into the base, the plurality of second sink grooves being smaller than the plurality of first sink grooves.

14. The super-hydrophobic structure of claim 13, wherein the plurality of first sink grooves are arranged in a first periodic array, and the plurality of second sink grooves are arranged in a second periodic array, the first periodic array overlapping with the second periodic array.

15. The super-hydrophobic structure of claim 13, wherein the plurality of first sink grooves are arranged in a repeating first hexagonal pattern, each of the plurality of first sink grooves forming at least one of a center and a vertex of a first hexagon of the repeating first hexagonal pattern.

16. The super-hydrophobic structure of claim 15, wherein the plurality of second sink grooves are arranged in a repeating second hexagonal pattern, each of the plurality of second sink grooves forming at least one of a center and a vertex of a second hexagon of the repeating second hexagonal pattern.

17. The super-hydrophobic structure of claim 13, wherein the plurality of first sink grooves extend to a first depth into the base, the plurality of second sink grooves extend to a second depth into the base, and the first depth is greater than the second depth.

18. The super-hydrophobic structure of claim 13, wherein the plurality of first sink grooves and second sink grooves do not extend through to the second surface of the base.

19. The super-hydrophobic structure of claim 13, further comprising:
a plurality of protrusion units disposed on the first surface and extending outward from the base.

20. The super-hydrophobic structure of claim 19, wherein the plurality of protrusion units are disposed between the plurality of second sink grooves, the plurality of protrusion units arranged in a periodic array.
